(19) United States
(12) Patent Application Publication
(10) Pub. No.: US 2009/0002273 A1
(43) Pub. Date: Jan. 1, 2009

(54) Data flow for a composite display

(75) Inventor: Clarence Chui, San Jose, CA (US)

Correspondence Address: VAN PELT, YI & JAMES LLP, 10050 N. FOOTHILL BLVD #200, CUPERTINO, CA, 95014, US

(73) Assignee: Boundary Net, Incorporated

(21) Appl. No.: 12/009,843

(22) Filed: Jan. 22, 2008

Related U.S. Application Data
(60) Provisional application No. 60/966,549, filed on Jun. 28, 2007.

(51) Int. Cl. G09G 3/00

(52) U.S. Cl. 345/31

(57) ABSTRACT

A system for generating a display is disclosed. The system includes a base on which one or more paddles are mounted, wherein each paddle includes a plurality of pixel elements and is configured to sweep out an area during a paddle cycle, a processor configured to generate a script based at least in part on a pixel map and an image, and a pixel element driver configured to receive at least a portion of the script and activate a pixel element on a paddle when the pixel element coincides with an image pixel of the image. At least a portion of the image is represented on the display by activating the pixel element.

### CROSS REFERENCE TO OTHER APPLICATIONS

This application claims priority to U.S. Provisional Patent Application No. 60/966,549 entitled COMPOSITE DISPLAY filed Jun. 28, 2007, which is incorporated herein by reference for all purposes.

### BACKGROUND OF THE INVENTION

Digital displays are used to display images or video to provide advertising or other information. For example, digital displays may be used in billboards, bulletins, posters, highway signs, and stadium displays. Digital displays that use liquid crystal display (LCD) or plasma technologies are limited in size because of size limits of the glass panels associated with these technologies. Larger digital displays typically comprise a grid of printed circuit board (PCB) tiles, where each tile is populated with packaged light emitting diodes (LEDs). Because of the space required by the LEDs, the resolution of these displays is relatively coarse. Also, each LED corresponds to a pixel in the image, which can be expensive for large displays. In addition, a complex cooling system is typically used to sink heat generated by the LEDs, which may burn out at high temperatures. As such, improvements to digital display technology are needed.

### BRIEF DESCRIPTION OF THE DRAWINGS

Various embodiments of the invention are disclosed in the following detailed description and the accompanying drawings.

FIG. 1 is a diagram illustrating an embodiment of a composite display 100 having a single paddle.

FIG. 2A is a diagram illustrating an embodiment of a paddle used in a composite display.

FIG. 2B illustrates an example of temporal pixels in a sweep plane.

FIG. 3 is a diagram illustrating an embodiment of a composite display 300 having two paddles.

FIG. 4A illustrates examples of paddle installations in a composite display.

FIG. 4B is a diagram illustrating an embodiment of a composite display 410 that uses masks.

FIG. 4C is a diagram illustrating an embodiment of a composite display 430 that uses masks.

FIG. 5 is a block diagram illustrating an embodiment of a system for displaying an image.

FIG. 6A is a diagram illustrating an embodiment of a composite display 600 having two paddles.

FIG. 6B is a flowchart illustrating an embodiment of a process for generating a pixel map.

FIG. 7 illustrates examples of paddles arranged in various arrays.

FIG. 8 illustrates examples of paddles with coordinated in phase motion to prevent mechanical interference.

FIG. 9 illustrating examples of paddles with coordinated out of phase motion to prevent mechanical interference.

FIG. 10 is a diagram illustrating an example of a cross section of a paddle in a composite display.

FIG. 11 is a block diagram illustrating an embodiment of a data flow for a system for displaying an image.

FIG. 12A is a flow chart illustrating an embodiment of a data flow process for a system for displaying an image.

FIG. 12B is an example of a script that may be generated.

FIG. 13 is a block diagram illustrating an embodiment of a data flow for a system for displaying an image.

FIG. 14 is a flow chart illustrating an embodiment of a data flow process for a system for displaying an image.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

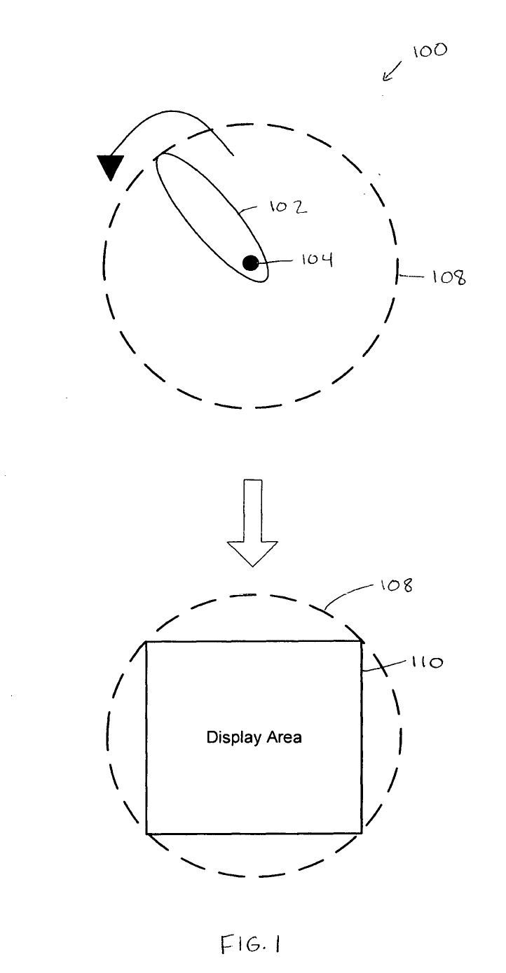

FIG. 1 is a diagram illustrating an embodiment of a composite display 100 having a single paddle. In the example shown, paddle 102 is configured to rotate at one end about axis of rotation 104 at a given frequency, such as 60 Hz. Paddle 102 sweeps out area 108 during one rotation or paddle cycle. A plurality of pixel elements, such as LEDs, is installed on paddle 102. As used herein, a pixel element refers to any element that may be used to display at least a portion of image information. As used herein, image or image information may include image, video, animation, slideshow, or any other visual information that may be displayed. Other examples of pixel elements include: laser diodes, phosphors, cathode ray tubes, liquid crystal, any transmissive or emissive optical modulator. Although LEDs may be described in the examples herein, any appropriate pixel elements may be used. In various embodiments, LEDS may be arranged on paddle 102 in a variety of ways, as more fully described below.

As paddle 102 sweeps out area 108, one or more of its LEDs are activated at appropriate times such that an image or a part thereof is perceived by a viewer who is viewing swept area 108. An image is comprised of pixels each having a spatial location. It can be determined at which spatial location a particular LED is at any given point in time. As paddle 102 rotates, each LED can be activated as appropriate when its location coincides with a spatial location of a pixel in the image. If paddle 102 is spinning fast enough, the eye perceives a continuous image. This is because the eye has a poor frequency response to luminance and color information. The eye integrates color that it sees within a certain time window. If a few images are flashed in a fast sequence, the eye integrates that into a single continuous image. This low temporal sensitivity of the eye is referred to as persistence of vision.

As such, each LED on paddle 102 can be used to display multiple pixels in an image. A single pixel in an image is mapped to at least one “temporal pixel” in the display area in composite display 100. A temporal pixel can be defined by a pixel element on paddle 102 and a time (or angular position of the paddle), as more fully described below.

The display area for showing the image or video may have any shape. For example, the maximum display area is circular and is the same as swept area 108. A rectangular image or video may be displayed within swept area 108 in a rectangular display area 110 as shown.

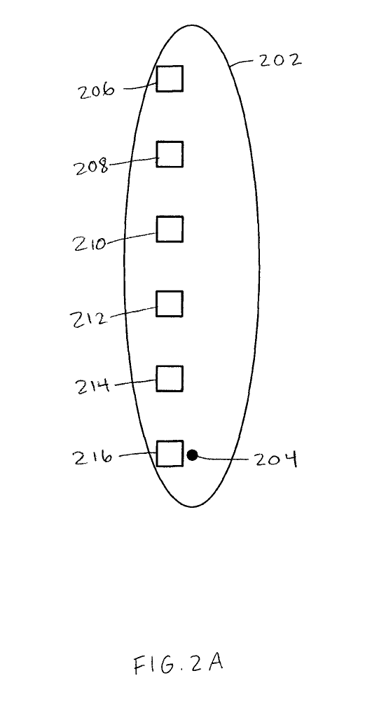

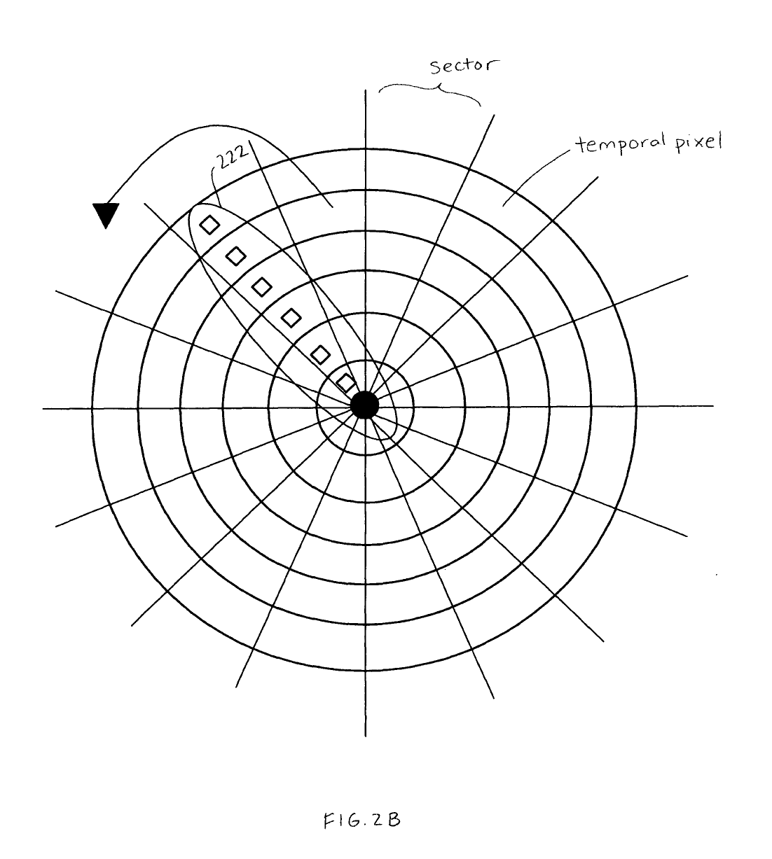

FIG. 2A is a diagram illustrating an embodiment of a paddle used in a composite display. For example, paddle 202, 302, or 312 (discussed later) may be similar to paddle 102. Paddle 202 is shown to include a plurality of LEDs 206-216 and an axis of rotation 204 about which paddle 202 rotates. LEDs 206-216 may be arranged in any appropriate way in various embodiments. In this example, LEDs 206-216 are arranged such that they are evenly spaced from each other and aligned along the length of paddle 202. They are aligned on the edge of paddle 202 so that LED 216 is adjacent to axis of rotation 204. This is so that as paddle 202 rotates, there is no blank spot in the middle (around axis of rotation 204). In some embodiments, paddle 202 is a PCB shaped like a paddle. In some embodiments, paddle 202 has an aluminum, metal, or other material casing for reinforcement.

FIG. 2B illustrates an example of temporal pixels in a sweep plane. In this example, each LED on paddle 222 is associated with an annulus (area between two circles) around the axis of rotation. Each LED can be activated once per sector (angular interval). Activating an LED may include, for example, turning on the LED for a prescribed time period (e.g., associated with a duty cycle) or turning off the LED. The intersections of the concentric circles and sectors form areas that correspond to temporal pixels. In this example, each temporal pixel has an angle of 42.5 degrees, so that there are a total of 16 sectors during which an LED may be turned on to indicate a pixel. Because there are 6 LEDs, there are 6*16=96 temporal pixels. In another example, a temporal pixel may have an angle of 1/10 of a degree, so that there are a total of 3600 angular positions possible.

Because the spacing of the LEDs along the paddle is uniform in the given example, temporal pixels get denser towards the center of the display (near the axis of rotation). Because image pixels are defined based on a rectangular coordinate system, if an image is overlaid on the display, one image pixel may correspond to multiple temporal pixels close to the center of the display. Conversely, at the outermost portion of the display, one image pixel may correspond to one or a fraction of a temporal pixel. For example, two or more image pixels may fit within a single temporal pixel. In some embodiments, the display is designed (e.g., by varying the sector time or the number/placement of LEDs on the paddle) so that at the outermost portion of the display, there is at least one temporal pixel per image pixel. This is to retain in the display the same level of resolution as the image. In some embodiments, the sector size is limited by how quickly LED control data can be transmitted to an LED driver to activate LED(s). In some embodiments, the arrangment of LEDs on the paddle is used to make the density of temporal pixels more uniform across the display. For example, LEDs may be placed closer together on the paddle the farther they are from the axis of rotation.

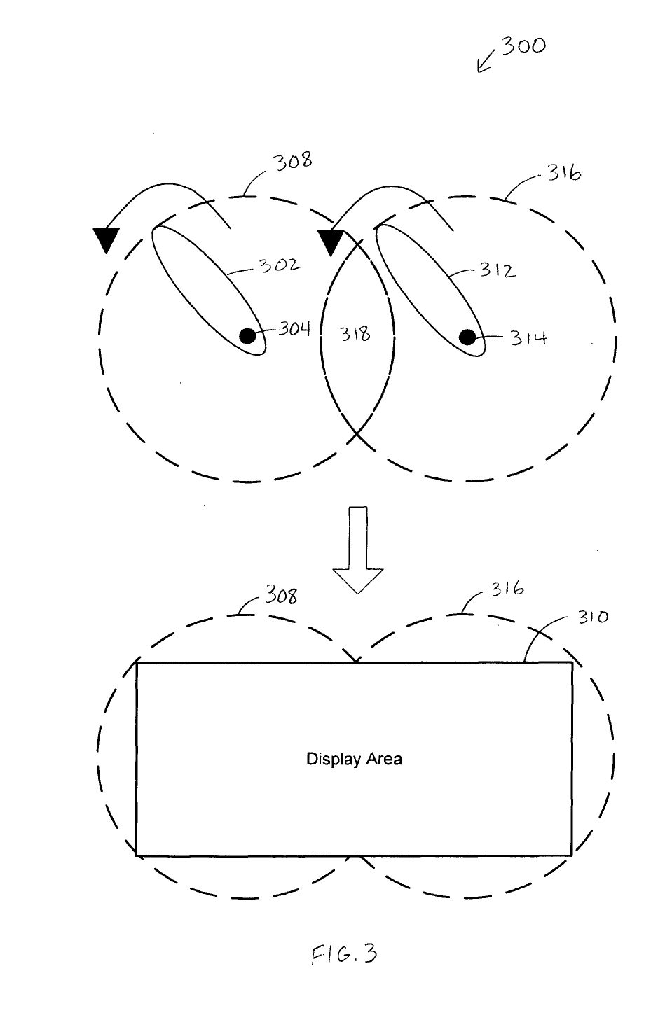

FIG. 3 is a diagram illustrating an embodiment of a composite display 300 having two paddles. In the example shown, paddle 302 is configured to rotate at one end about axis of rotation 304 at a given frequency, such as 60 Hz. Paddle 302 sweeps out area 308 during one rotation or paddle cycle. A plurality of pixel elements, such as LEDs, is installed on paddle 302. Paddle 312 is configured to rotate at one end about axis of rotation 314 at a given frequency, such as 60 Hz. Paddle 312 sweeps out area 316 during one rotation or paddle cycle. A plurality of pixel elements, such as LEDs, is installed on paddle 312. Swept areas 308 and 316 have an overlapping portion 318.

Using more than one paddle in a composite display may be desirable in order to make a larger display. For each paddle, it can be determined at which spatial location a particular LED is at any given point in time, so any image can be represented by a multiple paddle display in a manner similar to that described with respect to FIG. 1. In some embodiments, for overlapping portion 318, there will be twice as many LEDs passing through per cycle than in the nonoverlapping portions. This may make the overlapping portion of the display appear to the eye to have higher luminance. Therefore, in some embodiments, when an LED is in an overlapping portion, it may be activated half the time so that the whole display area appears to have the same luminance. This and other examples of handling overlapping areas are more fully described below.

The display area for showing the image or video may have any shape. The union of swept areas 308 and 316 is the maximum display area. A rectangular image or video may be displayed in rectangular display area 310 as shown.

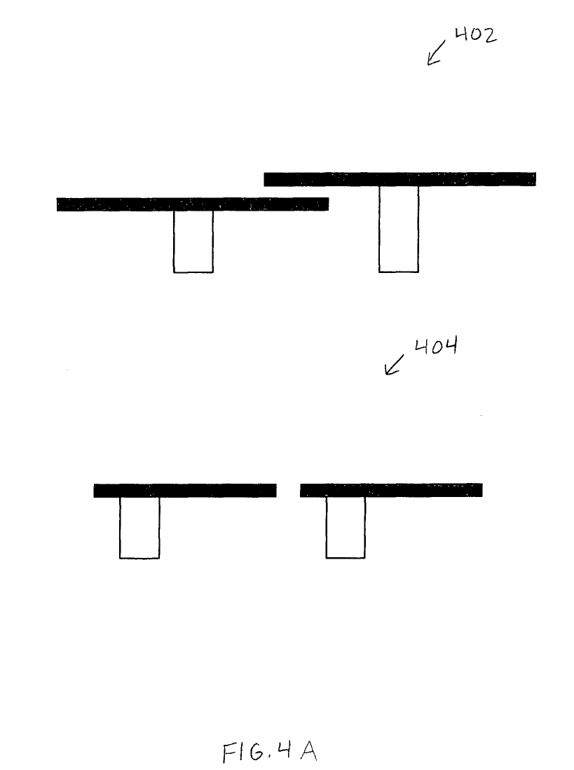

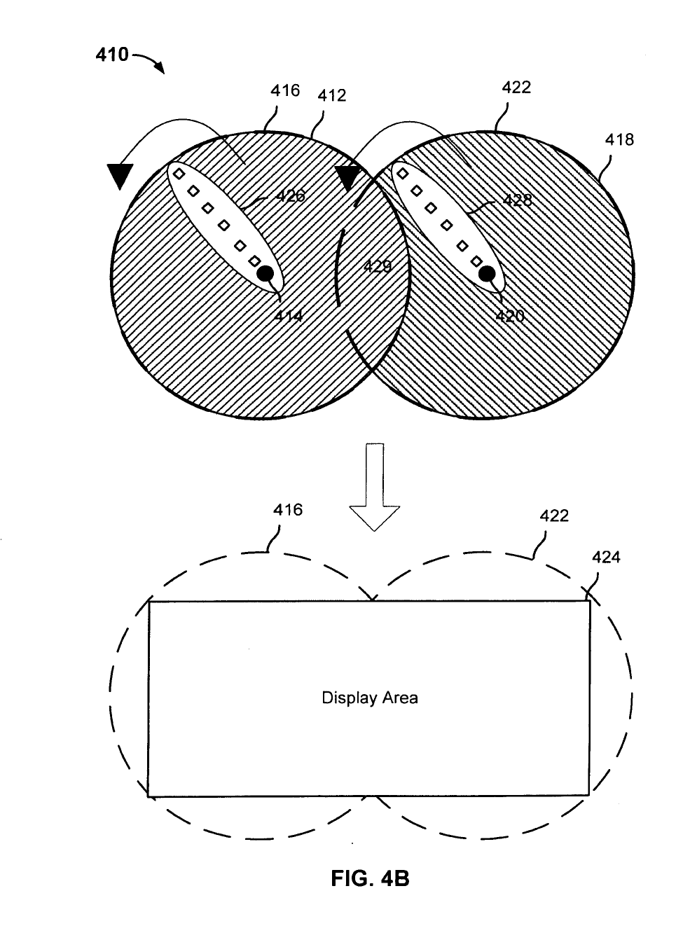

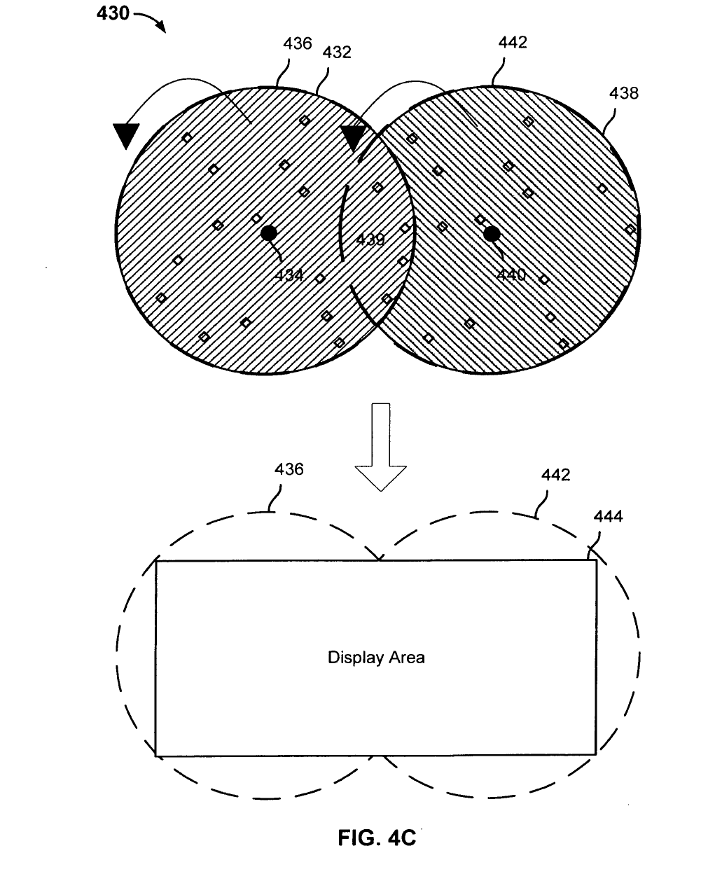

When using more than one paddle, there are various ways to ensure that adjacent paddles do not collide with each other. FIG. 4A illustrates examples of paddle installations in a composite display. In these examples, a cross section of adjacent paddles mounted on axes is shown.

In diagram 402, two adjacent paddles rotate in vertically separate sweep planes, ensuring that the paddles will not collide when rotating. This means that the two paddles can rotate at different speeds and do not need to be in phase with each other. To the eye, having the two paddles rotate in different sweep planes is not detectable if the resolution of the display is sufficiently smaller than the vertical spacing between the sweep planes. In this example, the axes are at the center of the paddles. This embodiment is more fully described below.

In diagram 404, the two paddles rotate in the same sweep plane. In this case, the rotation of the paddles is coordinated to avoid collision. For example, the paddles are rotated in phase with each other. Further examples of this are more fully described below.

In the case of the two paddles having different sweep planes, when viewing display area 310 from a point that is not normal to the center of display area 310, light may leak in diagonally between sweep planes. This may occur, for example, if the pixel elements emit unfocused light such that light is emitted at a range of angles. In some embodiments, a mask is used to block light from one sweep plane from being visible in another sweep plane. For example, a mask is placed behind paddle 302 and/or paddle 312. The mask may be attached to paddle 302 and/or 312 or stationary relative to paddle 302 and/or paddle 312. In some embodiments, paddle 302 and/or paddle 312 is shaped differently from that shown in FIGS. 3 and 4A, e.g., for masking purposes. For example, paddle 302 and/or paddle 312 may be shaped to mask the sweep area of the other paddle.

FIG. 4B is a diagram illustrating an embodiment of a composite display 410 that uses masks. In the example shown, paddle 426 is configured to rotate at one end about axis of rotation 414 at a given frequency, such as 60 Hz. A plurality of pixel elements, such as LEDs, is installed on paddle 426. Paddle 426 sweeps out area 416 (bold dashed line) during one rotation or paddle cycle. Paddle 428 is configured to rotate at one end about axis of rotation 420 at a given frequency, such as 60 Hz. Paddle 428 sweeps out area 422 (bold dashed line) during one rotation or paddle cycle. A plurality of pixel elements, such as LEDs, is installed on paddle 428.

In this example, mask 412 (solid line) is used behind paddle 426. In this case, mask 412 is the same shape as area 416 (i.e., a circle). Mask 412 masks light from pixel elements on paddle 428 from leaking into sweep area 416. Mask 412 may be installed behind paddle 426. In some embodiments, mask 412 is attached to paddle 426 and spins around axis of rotation 414 together with paddle 426. In some embodiments, mask 412 is installed behind paddle 426 and is stationary with respect to paddle 426. In this example, mask 418 (solid line) is similarly installed behind paddle 428.

In various embodiments, mask 412 and/or mask 418 may be made out of a variety of materials and have a variety of colors. For example, masks 412 and 418 may be black and made out of plastic.

The display area for showing the image or video may have any shape. The union of swept areas 416 and 422 is the maximum display area. A rectangular image or video may be displayed in rectangular display area 424 as shown.

Areas 416 and 422 overlap. As used herein, two elements (e.g., sweep area, sweep plane, mask, pixel element) overlap if they intersect in an x-y projection. In other words, if the areas are projected onto an x-y plane (defined by the x and y axes, where the x and y axes are in the plane of the figure), they intersect each other. Areas 416 and 422 do not sweep the same plane (do not have the same values of z, where the z axis is normal to the x and y axes), but they overlap each other in overlapping portion 429. In this example, mask 412 occludes sweep area 422 at overlapping portion 429 or occluded area 429. Mask 412 occludes sweep area 429 because it overlaps sweep area 429 and is on top of sweep area 429.

FIG. 4C is a diagram illustrating an embodiment of a composite display 430 that uses masks. In this example, pixel elements are attached to a rotating disc that functions as both a mask and a structure for the pixel elements. Disc 432 can be viewed as a circular shaped paddle. In the example shown, disc 432 (solid line) is configured to rotate at one end about axis of rotation 434 at a given frequency, such as 60 Hz. A plurality of pixel elements, such as LEDs, is installed on disc 432. Disc 432 sweeps out area 436 (bold dashed line) during one rotation or disc cycle. Disc 438 (solid line) is configured to rotate at one end about axis of rotation 440 at a given frequency, such as 60 Hz. Disc 438 sweeps out area 442 (bold dashed line) during one rotation or disc cycle. A plurality of pixel elements, such as LEDs, is installed on disc 438.

In this example, the pixel elements can be installed anywhere on discs 432 and 438. In some embodiments, pixel elements are installed on discs 432 and 438 in the same pattern. In other embodiments, different patterns are used on each disc. In some embodiments, the density of pixel elements is lower towards the center of each disc so the density of temporal pixels is more uniform than if the density of pixel elements is the same throughout the disc. In some embodiments, pixel elements are placed to provide redundancy of temporal pixels (i.e., more than one pixel is placed at the same radius). Having more pixel elements per pixel means that the rotation speed can be reduced. In some embodiments, pixel elements are placed to provide higher resolution of temporal pixels.

Disc 432 masks light from pixel elements on disc 438 from leaking into sweep area 436. In various embodiments, disc 432 and/or disc 438 may be made out of a variety of materials and have a variety of colors. For example, discs 432 and 438 may be black printed circuit board on which LEDs are installed.

The display area for showing the image or video may have any shape. The union of swept areas 436 and 442 is the maximum display area. A rectangular image or video may be displayed in rectangular display area 444 as shown.

Areas 436 and 442 overlap in overlapping portion 439. In this example, disc 432 occludes sweep area 442 at overlapping portion or occluded area 439.

In some embodiments, pixel elements are configured to not be activated when they are occluded. For example, the pixel elements installed on disc 438 are configured to not be activated when they are occluded, (e.g., overlap with occluded area 439). In some embodiments, the pixel elements are configured to not be activated in a portion of an occluded area. For example, an area within a certain distance from the edges of occluded area 439 is configured to not be activated. This may be desirable in case a viewer is to the left or right of the center of the display area and can see edge portions of the occluded area.

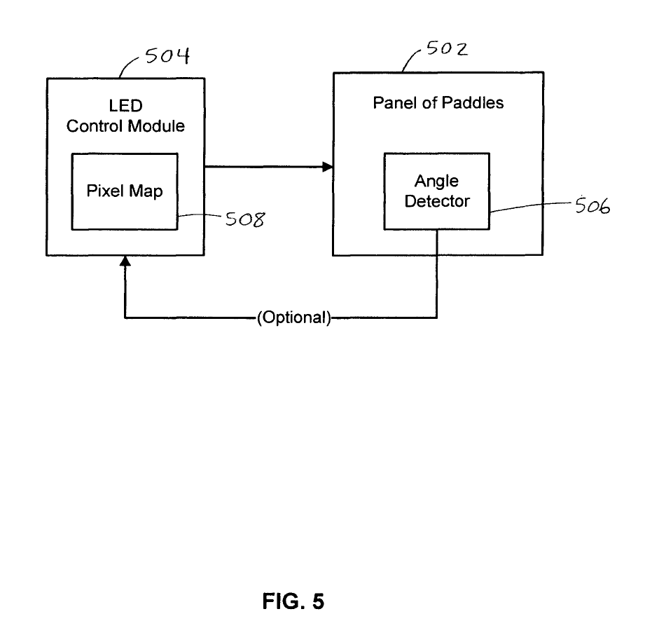

FIG. 5 is a block diagram illustrating an embodiment of a system for displaying an image. In the example shown, panel of paddles 502 is a structure comprising one or more paddles. As more fully described below, panel of paddles 502 may include a plurality of paddles, which may include paddles of various sizes, lengths, and widths; paddles that rotate about a midpoint or an endpoint; paddles that rotate in the same sweep plane or in different sweep planes; paddles that rotate in phase or out of phase with each other; paddles that have multiple arms; and paddles that have other shapes. Panel of paddles 502 may include all identical paddles or a variety of different paddles. The paddles may be arranged in a grid or in any other arrangement. In some embodiments, the panel includes angle detector 506, which is used to detect angles associated with one or more of the paddles. In some embodiments, there is an angle detector for each paddle on panel of paddles 502. For example, an optical detector may be mounted near a paddle to detect its current angle.

LED control module 504 is configured to optionally receive current angle information (e.g., angle(s) or information associated with angle(s)) from angle detector 506. LED control module 504 uses the current angles to determine LED control data to send to panel of paddles 502. The LED control data indicates which LEDs should be activated at that time (sector). In some embodiments, LED control module 504 determines the LED control data using pixel map 508. In some embodiments, LED control module 504 takes an angle as input and outputs which LEDs on a paddle should be activated at that sector for a particular image. In some embodiments, an angle is sent from angle detector 506 to LED control module 504 for each sector (e.g., just prior to the paddle reaching the sector). In some embodiments, LED control data is sent from LED control module 504 to panel of paddles 502 for each sector.

In some embodiments, pixel map 508 is implemented using a lookup table, as more fully described below. For different images, different lookup tables are used. Pixel map 508 is more fully described below.

In some embodiments, there is no need to read an angle using angle detector 506. Because the angular velocity of the paddles and an initial angle of the paddles (at that angular velocity) can be predetermined, it can be computed at what angle a paddle is at any given point in time. In other words, the angle can be determined based on the time. For example, if the angular velocity is ω, the angular location after time t is θᵢₙᵢₜᵢₐₗ+ωt where θᵢₙᵢₜᵢₐₗ is an initial angle once the paddle is spinning at steady state. As such, LED control module can serially output LED control data as a function of time (e.g., using a clock), rather than use angle measurements output from angle detector 506. For example, a table of time (e.g., clock cycles) versus LED control data can be built.

In some embodiments, when a paddle is starting from rest, it goes through a start up sequence to ramp up to the steady state angular velocity. Once it reaches the angular velocity, an initial angle of the paddle is measured in order to compute at what angle the paddle is at any point in time (and determine at what point in the sequence of LED control data to start).

In some embodiments, angle detector 506 is used periodically to provide adjustments as needed. For example, if the angle has drifted, the output stream of LED control data can be shifted. In some embodiments, if the angular speed has drifted, mechanical adjustments are made to adjust the speed.

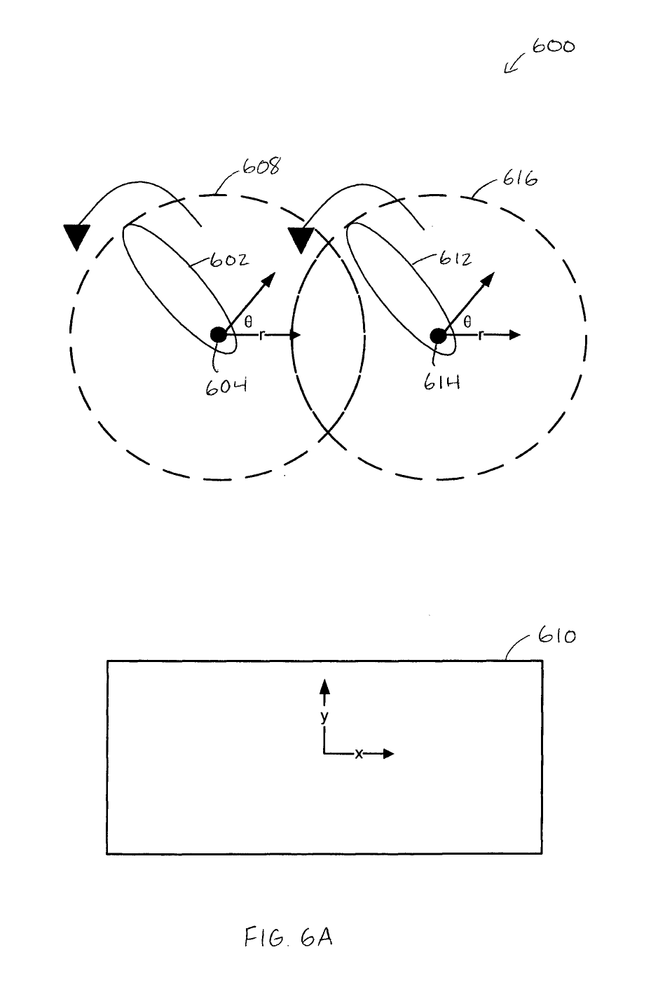

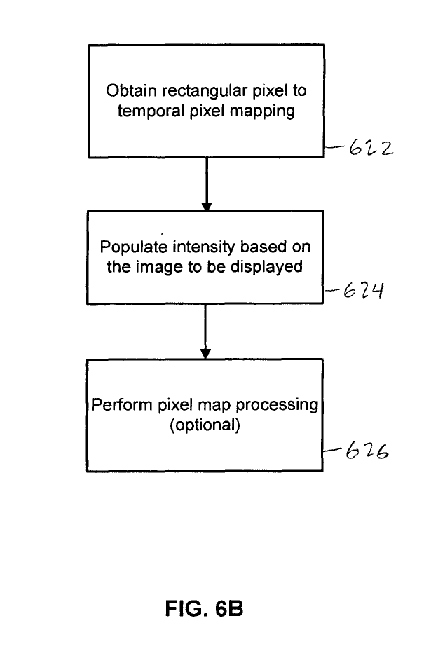

FIG. 6A is a diagram illustrating an embodiment of a composite display 600 having two paddles. In the example shown, a polar coordinate system is indicated over each of areas 608 and 616, with an origin located at each axis of rotation 604 and 614. In some implementations, the position of each LED on paddles 602 and 612 is recorded in polar coordinates. The distance from the origin to the LED is the radius r. The paddle angle is θ. For example, if paddle 602 is in the 3 o'clock position, each of the LEDs on paddle 602 is at 0 degrees. If paddle 602 is in the 12 o'clock position, each of the LEDs on paddle 602 is at 90 degrees. In some embodiments, an angle detector is used to detect the current angle of each paddle. In some embodiments, a temporal pixel is defined by P, r, and θ, where P is a paddle identifier and (r, θ) are the polar coordinates of the LED.

A rectangular coordinate system is indicated over an image 610 to be displayed. In this example, the origin is located at the center of image 610, but it may be located anywhere depending on the implementation. In some embodiments, pixel map 508 is created by mapping each pixel in image 610 to one or more temporal pixels in display area 608 and 616. Mapping may be performed in various ways in various embodiments.

FIG. 6B is a flowchart illustrating an embodiment of a process for generating a pixel map. For example, this process may be used to create pixel map 508. At 622, an image pixel to temporal pixel mapping is obtained. In some embodiments, mapping is performed by overlaying image 610 (with its rectangular grid of pixels (x, y) corresponding to the resolution of the image) over areas 608 and 616 (with their two polar grids of temporal pixels (r, θ), e.g., see FIG. 2B). For each image pixel (x, y), it is determined which temporal pixels are within the image pixel. The following is an example of a pixel map:

TABLE 1

| | | |
|---|---|---|
| Image pixel (x, y) | Temporal Pixel (P, r, θ) | Intensity (f) |

| | |
|---|---|
| (a1, a2) | (b1, b2, b3) |
| (a3, a4) | (b4, b5, b6); (b7, b8, b9) |
| (a5, a6) | (b10, b11, b12) |
| etc. | etc. |

As previously stated, one image pixel may map to multiple temporal pixels as indicated by the second row. In some embodiments, instead of r, an index corresponding to the LED is used. In some embodiments, the image pixel to temporal pixel mapping is precomputed for a variety of image sizes and resolutions (e.g., that are commonly used).

At 624, an intensity f is populated for each image pixel based on the image to be displayed. In some embodiments, f indicates whether the LED should be on (e.g., 1) or off (e.g., 0). For example, in a black and white image (with no grayscale), black pixels map to f=1 and white pixels map to f=0. In some embodiments, f may have fractional values. In some embodiments, f is implemented using duty cycle management. For example, when f is 0, the LED is not activated for that sector time. When f is 1, the LED is activated for the whole sector time. When f is 0.5, the LED is activated for half the sector time. In some embodiments, f can be used to display grayscale images. For example, if there are 256 gray levels in the image, pixels with gray level 128 (half luminance) would have f=0.5. In some embodiments, rather than implement f using duty cycle (i.e., pulse width modulated), f is implemented by adjusting the current to the LED (i.e., pulse height modulation).

For example, after the intensity f is populated, the table may appear as follows:

TABLE 2

| Image pixel (x, y) | Temporal Pixel (P, r, θ) | Intensity (f) |
|---|---|---|
| (a1, a2) | (b1, b2, b3) | f1 |
| (a3, a4) | (b4, b5, b6); (b7, b8, b9) | f2 |
| (a5, a6) | (b10, b11, b12) | f3 |
| etc. | etc. | etc. |

At 626, optional pixel map processing is performed. This may include compensating for overlap areas, balancing luminance in the center (i.e., where there is a higher density of temporal pixels), balancing usage of LEDs, etc. For example, when LEDs are in an overlap area (and/or on a boundary of an overlap area), their duty cycle may be reduced. For example, in composite display 300, when LEDs are in overlap area 318, their duty cycle is halved. In some embodiments, there are multiple LEDs in a sector time that correspond to a single image pixel, in which case, fewer than all the LEDs may be activated (i.e., some of the duty cycles may be set to 0). In some embodiments, the LEDs may take turns being activated (e.g., every N cycles where N is an integer), e.g., to balanced usage so that one doesn't burn out earlier than the others. In some embodiments, the closer the LEDs are to the center (where there is a higher density of temporal pixels), the lower their duty cycle.

For example, after luminance balancing, the pixel map may appear as follows:

TABLE 3

| Image pixel (x, y) | Temporal Pixel (P, r, θ) | Intensity (f) |
|---|---|---|
| (a1, a2) | (b1, b2, b3) | f1 |
| (a3, a4) | (b4, b5, b6) | f2 |
| (a5, a6) | (b10, b11, b12) | f3 |
| etc. | etc. | etc. |

As shown, in the second row, the second temporal pixel was deleted in order to balance luminance across the pixels. This also could have been accomplished by halving the intensity to f2/2. As another alternative, temporal pixel (b4, b5, b6) and (b7, b8, b9) could alternately turn on between cycles. In some embodiments, this can be indicated in the pixel map. The pixel map can be implemented in a variety of ways using a variety of data structures in different implementations.

For example, in FIG. 5, LED control module 504 uses the temporal pixel information (P, r, θ, and f) from the pixel map. LED control module 504 takes θ as input and outputs LED control data P, r, and f. Panel of paddles 502 uses the LED control data to activate the LEDs for that sector time. In some embodiments, there is an LED driver for each paddle that uses the LED control data to determine which LEDs to turn on, if any, for each sector time.

Any image (including video) data may be input to LED control module 504. In various embodiments, one or more of 622, 624, and 626 may be computed live or in real time, i.e., just prior to displaying the image. This may be useful for live broadcast of images, such as a live video of a stadium. For example, in some embodiments, 622 is precomputed and 624 is computed live or in real time. In some implementations, 626 may be performed prior to 622 by appropriately modifying the pixel map. In some embodiments, 622, 624, and 626 are all precomputed. For example, advertising images may be precomputed since they are usually known in advance.

The process of FIG. 6B may be performed in a variety of ways in a variety of embodiments. Another example of how 622 may be performed is as follows. For each image pixel (x, y), a polar coordinate is computed. For example, (the center of) the image pixel is converted to polar coordinates for the sweep areas it overlaps with (there may be multiple sets of polar coordinates if the image pixel overlaps with an overlapping sweep area). The computed polar coordinate is rounded to the nearest temporal pixel. For example, the temporal pixel whose center is closest to the computed polar coordinate is selected. (If there are multiple sets of polar coordinates, the temporal pixel whose center is closest to the computed polar coordinate is selected.) This way, each image pixel maps to at most one temporal pixel. This may be desirable because it maintains a uniform density of activated temporal pixels in the display area (i.e., the density of activated temporal pixels near an axis of rotation is not higher than at the edges). For example, instead of the pixel map shown in Table 1, the following pixel map may be obtained:

TABLE 4

| | | |
|---|---|---|
| Image pixel (x, y) | Temporal Pixel (P, r, θ) | Intensity (f) |

| | |
|---|---|
| (a1, a2) | (b1, b2, b3) |
| (a3, a4) | (b7, b8, b9) |
| (a5, a6) | (b10, b11, b12) |
| etc. | etc. |

In some cases, using this rounding technique, two image pixels may map to the same temporal pixel. In this case, a variety of techniques may be used at 626, including, for example: averaging the intensity of the two rectangular pixels and assigning the average to the one temporal pixel; alternating between the first and second rectangular pixel intensities between cycles; remapping one of the image pixel to a nearest neighbor temporal pixel; etc.

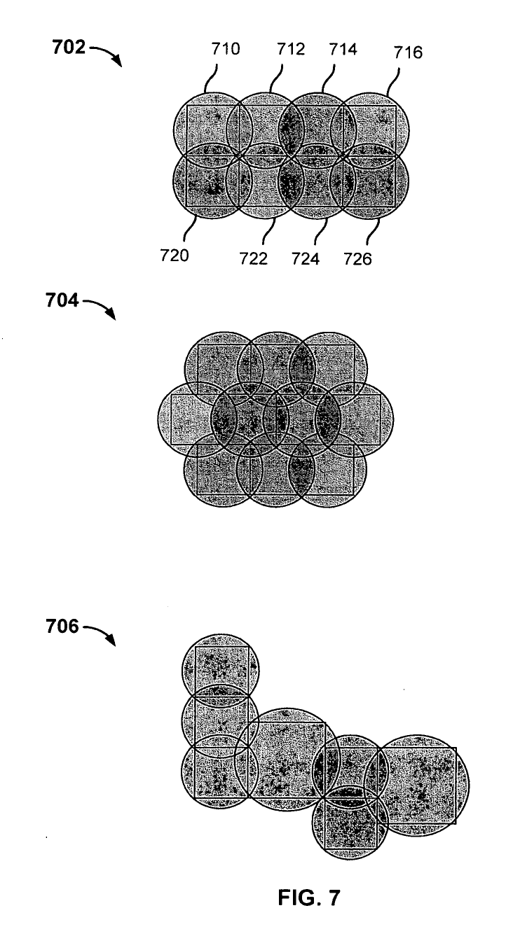

FIG. 7 illustrates examples of paddles arranged in various arrays. For example, any of these arrays may comprise panel of paddles 502. Any number of paddles may be combined in an array to create a display area of any size and shape.

Arrangement 702 shows eight circular sweep areas corresponding to eight paddles each with the same size. The sweep areas overlap as shown. In addition, rectangular display areas are shown over each sweep area. For example, the maximum rectangular display area for this arrangement would comprise the union of all the rectangular display areas shown. To avoid having a gap in the maximum display area, the maximum spacing between axes of rotation is \sqrt{2}R, where R is the radius of one of the circular sweep areas. The spacing between axes is such that the periphery of one sweep area does not overlap with any axes of rotation, otherwise there would be interference. Any combination of the sweep areas and rectangular display areas may be used to display one or more images.

In some embodiments, the eight paddles are in the same sweep plane. In some embodiments, the eight paddles are in different sweep planes. It may be desirable to minimize the number of sweep planes used. For example, it is possible to have every other paddle sweep the same sweep plane. For example, sweep areas 710, 714, 722, and 726 can be in the same sweep plane, and sweep areas 712, 716, 720, and 724 can be in another sweep plane.

In some configurations, sweep areas (e.g., sweep areas 710 and 722) overlap each other. In some configurations, sweep areas are tangent to each other (e.g., sweep areas 710 and 722 can be moved apart so that they touch at only one point). In some configurations, sweep areas do not overlap each other (e.g., sweep areas 710 and 722 have a small gap between them), which is acceptable if the desired resolution of the display is sufficiently low.

Arrangement 704 shows ten circular sweep areas corresponding to ten paddles. The sweep areas overlap as shown. In addition, rectangular display areas are shown over each sweep area. For example, three rectangular display areas, one in each row of sweep areas, may be used, for example, to display three separate advertising images. Any combination of the sweep areas and rectangular display areas may be used to display one or more images.

Arrangement 706 shows seven circular sweep areas corresponding to seven paddles. The sweep areas overlap as shown. In addition, rectangular display areas are shown over each sweep area. In this example, the paddles have various sizes so that the sweep areas have different sizes. Any combination of the sweep areas and rectangular display areas may be used to display one or more images. For example, all the sweep areas may be used as one display area for a non-rectangular shaped image, such as a cut out of a giant serpent.

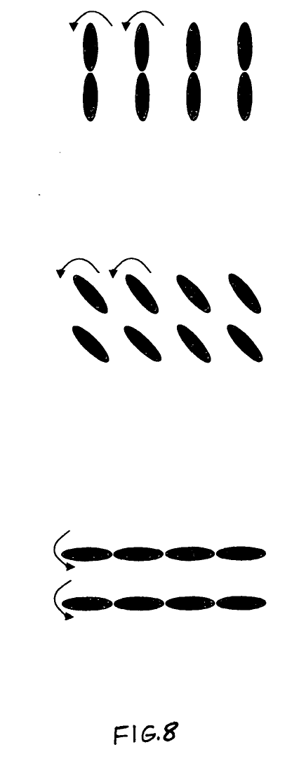

FIG. 8 illustrates examples of paddles with coordinated in phase motion to prevent mechanical interference. In this example, an array of eight paddles is shown at three points in time. The eight paddles are configured to move in phase with each other; that is, at each point in time, each paddle is oriented in the same direction (or is associated with the same angle when using the polar coordinate system described in FIG. 6A).

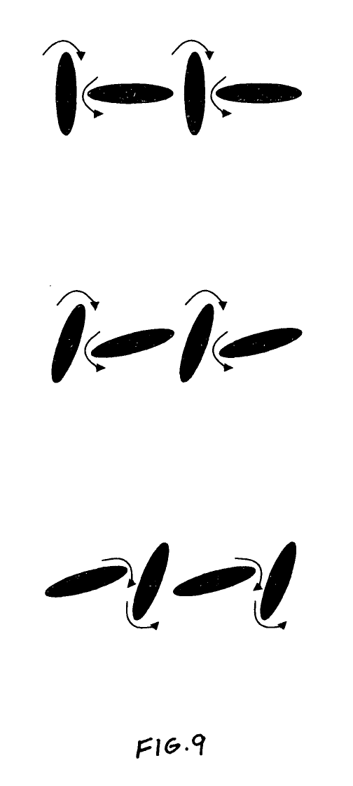

FIG. 9 illustrating examples of paddles with coordinated out of phase motion to prevent mechanical interference. In this example, an array of four paddles is shown at three points in time. The four paddles are configured to move out of phase with each other; that is, at each point in time, at least one paddle is not oriented in the same direction (or is associated with the same angle when using the polar coordinate system described in FIG. 6A) as the other paddles. In this case, even though the paddles move out of phase with each other, their phase difference (difference in angles) is such that they do not mechanically interfere with each other.

The display systems described herein have a naturally built in cooling system. Because the paddles are spinning, heat is naturally drawn off of the paddles. The farther the LED is from the axis of rotation, the more cooling it receives. In some embodiments, this type of cooling is at least 10× effective as systems in which LED tiles are stationary and in which an external cooling system is used to blow air over the LED tiles using a fan. In addition, a significant cost savings is realized by not using an external cooling system.

Although in the examples herein, the image to be displayed is provided in pixels associated with rectangular coordinates and the display area is associated with temporal pixels described in polar coordinates, the techniques herein can be used with any coordinate system for either the image or the display area.

Although rotational movement of paddles is described herein, any other type of movement of paddles may also be used. For example, a paddle may be configured to move from side to side (producing a rectangular sweep area, assuming the LEDs are aligned in a straight row). A paddle may be configured to rotate and simultaneously move side to side (producing an elliptical sweep area). A paddle may have arms that are configured to extend and retract at certain angles, e.g., to produce a more rectangular sweep area. Because the movement is known, a pixel map can be determined, and the techniques described herein can be applied.

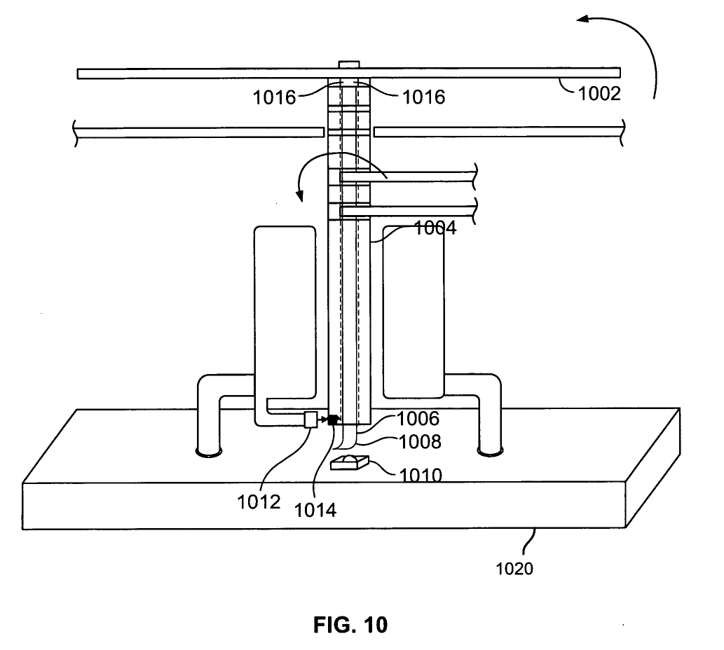

FIG. 10 is a diagram illustrating an example of a cross section of a paddle in a composite display. This example is shown to include paddle 1002, shaft 1004, optical fiber 1006, optical camera 1012, and optical data transmitter 1010. Paddle 1002 is attached to shaft 1004. Shaft 1004 is bored out (i.e., hollow) and optical fiber 1006 runs through its center. The base 1008 of optical fiber 1006 receives data via optical data transmitter 1010. The data is transmitted up optical fiber 1006 and transmitted at 1016 to an optical detector (not shown) on paddle 1002. The optical detector provides the data to one or more LED drivers used to activate one or more LEDs on paddle 1002. In some embodiments, LED control data that is received from LED control module 504 is transmitted to the LED driver in this way.

In some embodiments, the base of shaft 1004 has appropriate markings 1014 that are read by optical camera 1012 to determine the current angular position of paddle 1002. In some embodiments, optical camera 1012 is used in conjunction with angle detector 506 to output angle information that is fed to LED control module 508 as shown in FIG. 5.

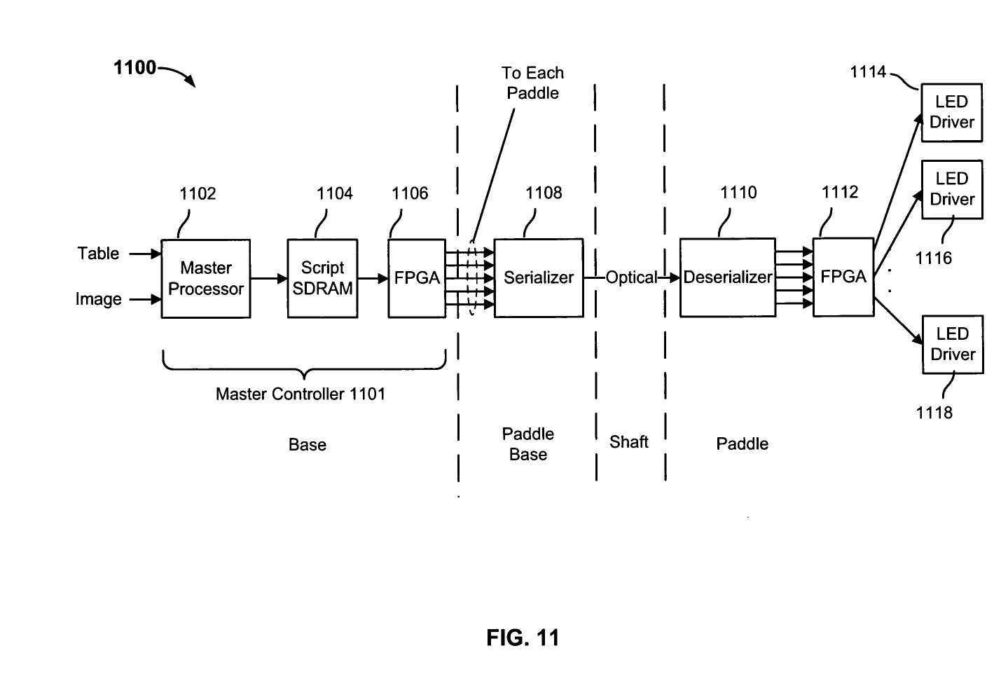

FIG. 11 is a block diagram illustrating an embodiment of a data flow for a system for displaying an image. In the example shown, system 1100 includes a base and one or more paddles mounted on the base. As used herein, “paddle base” refers to a portion of the base on which a paddle is mounted, where the portion includes one or more devices (e.g., integrated circuits or chips) associated with (e.g., used to control) the paddle. An example of a paddle base is paddle base 1020 in FIG. 10. One or more chips may be mounted on paddle base 1020.

System 1100 includes various logical blocks, one or more of which may correspond to a physical device, such as a chip. System 1100 includes: master controller 1101, serializer 1108, deserializer 1110, FPGA 1112, and LED drivers 1114-1118. Master controller 1101 includes: master processor 1102, SDRAM 1104, and FPGA 1106. In this example, master controller 1101 is used to generate a master script for all paddles and all LEDs. Each paddle is then sent a local script, which is a portion of the master script corresponding to that paddle. As such, system 1100 shows an example of upfront processing.

Although an SDRAM and FPGAs are shown in this example, in various embodiments, other appropriate memory components may be used. A lookup table and image data are provided as input to master processor 1102. The output of master processor is input to SDRAM 1104, whose output is coupled to FPGA 1106. The output of FPGA 1106 is coupled to serializer 1108. The output of serializer 1108 is sent over an optical link to deserializer 1110. The output of deserializer 1110 is coupled to FPGA 1112, whose output is coupled to each of LED drivers 1114-1118. In some embodiments, the optical link is associated with a shaft of a paddle. For example, in FIG. 10, there is an optical link between optical data transmitter 1010 and an optical detector on paddle 1002. The optical link includes optical fiber 1006 which runs through the center of shaft 1004, as previously described.

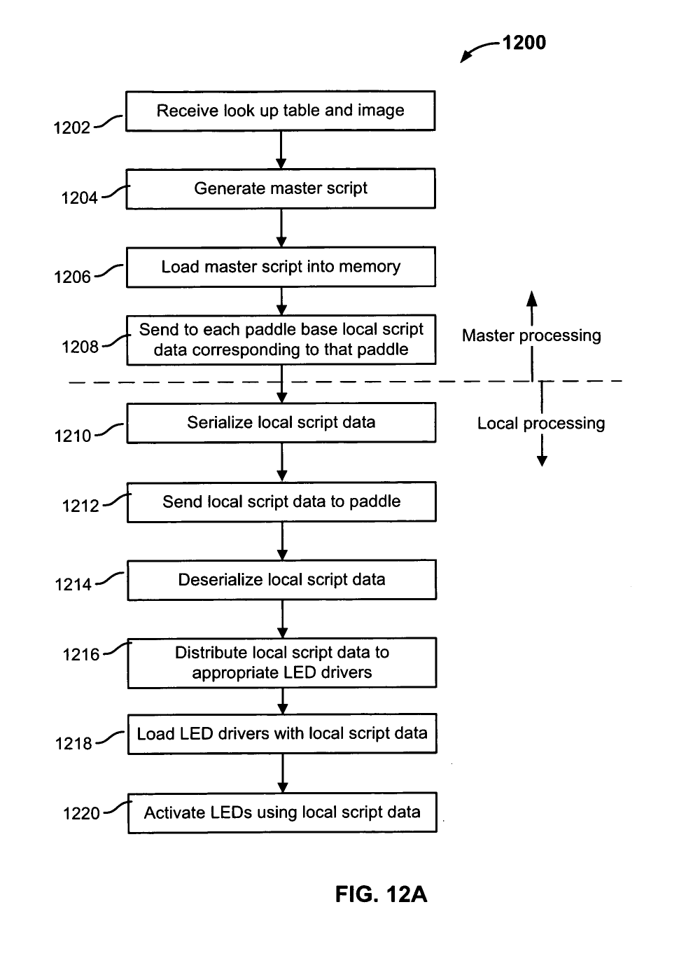

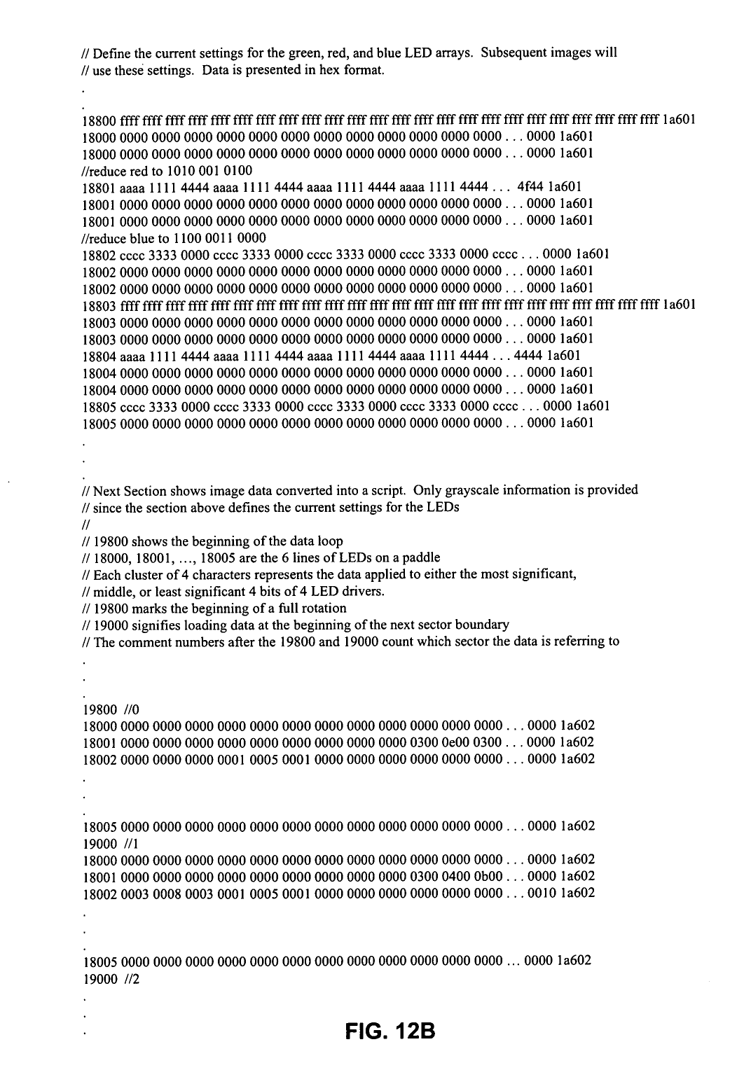

In some embodiments, SDRAM 1104 and FPGA 1106 are located on a base, serializer 1108 is located on a paddle base, and deserializer 1110, FPGA 1112, and LED drivers 1114-1118 are located on a paddle. If there is more than one paddle, then blocks 1108-1118 are replicated for each paddle. Other appropriate configurations are possible. For example, in some embodiments, FPGA 1112 is located on each paddle base. An example data flow process is described with respect to FIG. 12.

FIG. 12A is a flow chart illustrating an embodiment of a data flow process for a system for displaying an image. At 1202, a lookup table and image are received. For example, master processor 1102 receives the lookup table and image. The lookup table is used to map an image pixel to a temporal pixel. For example, the lookup table may be constructed based on a pixel map, such as that shown in the first two columns of Table 4. In some embodiments, for different image sizes and display sizes, the lookup table is different.

At 1204, a master script is generated. For example, master processor 1102 generates the master script using the lookup table and image. A master script is a sequence of data indicating which LEDs on which paddle should be activated at what intensity and at what time.

FIG. 12B is an example of a script that may be generated. This script is arranged into 2 sections: The first section defines the current settings that will be used by each green, red, and blue LED array; the second provides the gray scale information that should be applied to each LED during every sector. Comments are indicated after “//”.

Returning to FIG. 12A, in some embodiments, script data includes LED driver chip control commands, timing information, LED current settings, and LED grayscale information. The image data includes, for example, the grayscale information that should be applied to each LED at each instant in time. The timing information is used to make sure the LED data is presented to the LED array at the correct angular location (i.e., the sector data corresponds to the appropriate angle of rotation of the paddles) and to make sure the data between two or more paddles is synchronized.

In some embodiments, the image data is loaded into the LED driver one temporal pixel at a time via a serial shift register. The image data takes the form of a 12 bit word (hence 12 bits of grayscale). Once all of the image data is clocked into the driver for all of the connected LEDs (16 in this case) the image data is then latched into a set of registers (in parallel) where it's ready to be used to trigger the activation of the connected LEDs. After the image data is latched and ready, there are two signals that are generated on board the paddle that are used to initiate and hold the timing of the actuations 1) a grayscale “start” signal (which marks the beginning of a sector) 2) the clock signal. The grayscale “start” command tells the driver to start activating the LEDs (in parallel) and to start a clock counter that is compared to the image data latched into the registers. If the counter exceeds the value of the image data in the register the LED is deactivated. This comparison of image data and counter is done within the internal capability of the driver. In some embodiments, for each sector, there needs to be at least 4096 clock cycles available (i.e., 12 bits of information) to get the full grayscale capability through temporal modulation. In some cases, an additional 2 cycles are added since the grayscale “start” signal needs a couple of clock cycles ahead of it to work properly (i.e, 4098 clock cycles per angular slice). While the latched image data is being displayed on the LEDs, the next line of image data is being loaded through the serial shift register so image data is in effect being streamed onto the LED driver without the need for additional buffering/memory.

In some embodiments, the master script is generated outside of system 1100 and input directly into SDRAM 1104, eliminating the need for master processor 1102. The master script may be pre-generated or generated in real time. For example, for live broadcast of a video (which comprises one or more images), the master script may be generated in hardware in real time.

At 1206, the master script is loaded into memory. For example, the master script is loaded into SDRAM 1104. At 1208, local script data associated with a paddle is sent to that paddle base. For example, FPGA 1106 parses the master script data into local script data for each paddle, and then sends to each paddle base local script data corresponding to that paddle. The link between the base (e.g., FPGA 1106) and each paddle base may be implemented in a variety of ways in various embodiments. For example, an optical link may be used.

At 1210, local script data is serialized. For example, serializer 1108 serializes the local script data for the purpose of sending it over an optical link up the paddle shaft to the paddle. In other embodiments, the data does not need to be serialized to be sent to the paddle. At 1212, the local script data is sent to the paddle. The local script data may be sent via an optical link, as previously described and as shown in FIG. 10. Other options for sending the local script data from the paddle base to the paddle include using brushes or a wireless or IR (infrared) link. Any data link with sufficient throughput may be used.

At 1214, the local script data is deserialized. For example, deserializer 1110 deserializes the local script data. At 1216, the local script data is distributed to the appropriate LED drivers on the paddle. For example, FPGA 1112 reformats the deserialized local script data so it goes to the correct LED driver. In some embodiments, once FPGA 1106 sends the data over to the paddle the data is streamed onto the LED drivers without any need to buffer the local frame information. At 1218, the LED drivers are loaded with the local script data. For example, LED drivers 1114-1118 are loaded with the local script data. In some embodiments, two or more LED drivers are mounted on a paddle to drive different sets of LEDs. For example, an LED driver may be capable of driving 16 LEDs. In some embodiments, each LED driver receives a portion of the local script data(e.g., LED driver chip control commands, timing information, LED current settings, and LED grayscale information) corresponding to the LED driver. Some LED drivers have pulse width control, which means that if the image pixel is at grayscale level 252 out of 256, the LED will be on for 252 out of 256 time slices. Some LED drivers do not have pulse width control. In this case, the image data in the master script and local script data includes information about whether to turn on and off an LED for each clock cycle. At 1220, the LEDs are activated using the local script data.

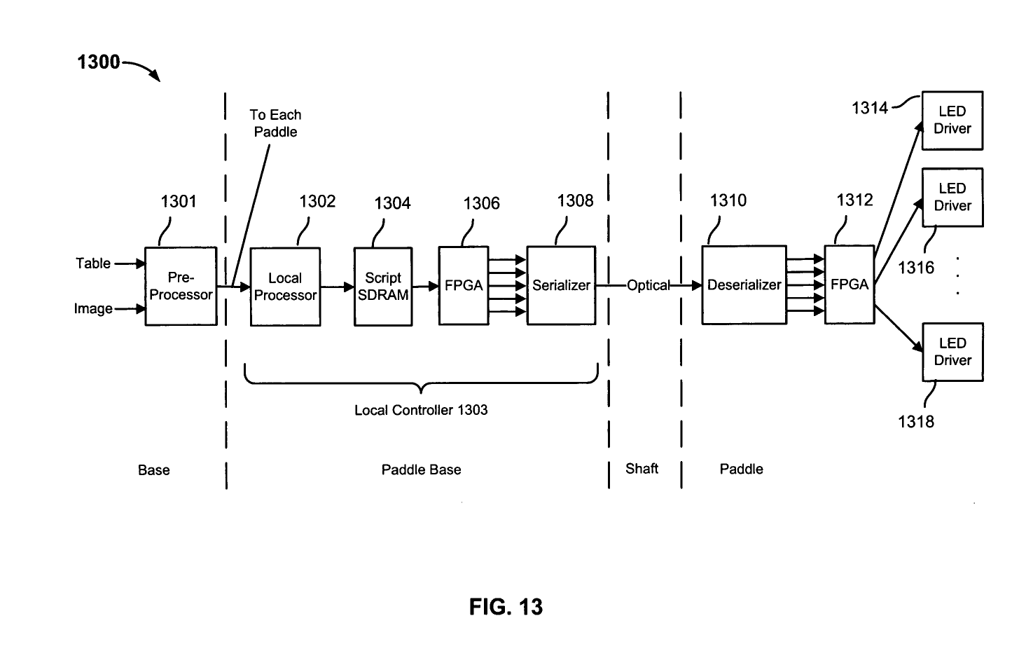

FIG. 13 is a block diagram illustrating an embodiment of a data flow for a system for displaying an image. In the example shown, system 1300 includes a base and one or more paddles mounted on the base.

System 1300 includes various logical blocks, one or more of which may correspond to a physical device, such as a chip. System 1300 includes: pre-processor 1301, local controller 1303, deserializer 1310, FPGA 1312, and LED drivers 1314-1318. Local controller 1303 includes: local processor 1302, SDRAM 1304, FPGA 1306, and serializer 1308. In this example, pre-processor 1301 is used to send to each paddle base a local portion of the image and a local portion of the table corresponding to that paddle. Each paddle base then uses the local portion of the image and the local portion of the table to generate a local script. As such, system 1300 shows an example of parallel processing to generate local scripts. In contrast, in system 1100, a master script is generated and parsed into local scripts at a master controller, and the local scripts are sent to paddle bases. In system 1300, local scripts are generated at each paddle base.

Although an SDRAM is shown in this example, in various embodiments, other appropriate memory components may be used. A lookup table and image data are provided as input to pre-processor 1301. The output of pre-processor 1301 is sent to local processor 1302, whose output is coupled to SDRAM 1304, whose output is coupled to FPGA 1306. The output of FPGA 1306 is coupled to serializer 1308. The output of serializer 1308 is sent over an optical link to deserializer 1310. The output of deserializer 1310 is coupled to FPGA 1312, whose output is coupled to each of LED drivers 1314-1318. In some embodiments, the optical link is associated with a shaft of a paddle, as previously described.

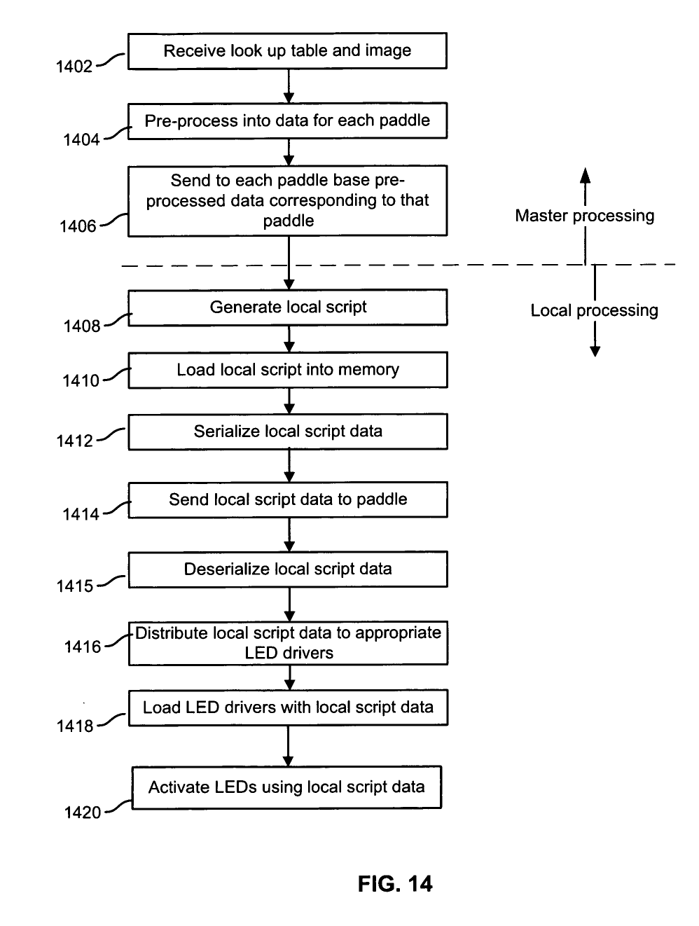

In some embodiments, pre-processor 1301 is located on a base, local processor 1302, SDRAM 1304, FPGA 1306, and serializer 1308 are located on a paddle base, and deserializer 1310, FPGA 1312, and LED drivers 1314-1318 are located on a paddle. If there is more than one paddle, then blocks 1302-1318 are replicated for each paddle. Other appropriate configurations are possible. An example data flow process is described with respect to FIG. 14.

FIG. 14 is a flow chart illustrating an embodiment of a data flow process for a system for displaying an image. At 1402, a lookup table and image are received. For example, pre-processor 1301 receives the lookup table and image. The lookup table is used to map an image pixel to a temporal pixel. For example, the lookup table may be constructed based on a pixel map, such as that shown in the first two columns of Table 4. In some embodiments, for different image sizes and display sizes, the lookup table is different.

At 1404, the lookup table and image are pre-processed into data for each paddle. For example, pre-processor 1301 parses the lookup table and image into portions that correspond to each paddle. As used herein, the portion of the lookup table corresponding to a paddle and the portion of an image corresponding to a paddle is referred to as a local lookup table and a local image, respectively. In some embodiments, a local lookup table is the portion that maps to temporal pixels to be displayed on the paddle. In some embodiments, a local image is the portion of the image to be displayed on the paddle. At 1406, the pre-processed data is sent to each paddle base. For example, pre-processor 1301 sends to each paddle base a local lookup table and a local image for the paddle. The link between the base (e.g., pre-processor 1301) and each paddle base may be implemented in a variety of ways in various embodiments. For example, an optical link may be used.

At 1408, a local script is generated. For example, local processor 1302 receives a local lookup table and local image. Local processor 1302 then generates the local script using the local lookup table and local image. A local script is a sequence of data indicating which LEDs on the local paddle should be activated at what intensity and at what time. In some embodiments, local script data includes clock data, load data, and image data, as previously described.

In some embodiments, the local script is generated outside of system 1300 and input directly into SDRAM 1304, eliminating the need for local processor 1302. The local script may be pre-generated or generated in real time. For example, for live broadcast of a video (which comprises one or more images), the local script may be generated in hardware in real time.

In some embodiments, the local lookup table is pre-stored on the paddle base. In this case, the lookup table is not input at 1402 (to pre-processor 1301), and the local lookup table is not passed from pre-processor 1301 to the paddle base.

At 1410, the local script is loaded into memory. For example, the local script is loaded into SDRAM 1304. At 1412, local script data is serialized. For example, FPGA 1306 can help manage high level functions that may be embedded in the local script (e.g., performing loops or repeating data, etc.) For example, serializer 1308 serializes the local script data for the purpose of sending it over an optical link up the paddle shaft to the paddle. In other embodiments, the data does not need to be serialized to be sent to the paddle. At 1414, the local script data is sent to the paddle. The local script data may be sent via an optical link, as previously described and as shown in FIG. 10. Other options for sending the local script data from the paddle base to the paddle include using brushes or a wireless or IR (infrared) link. Any data link with sufficient throughput may be used.

At 1415, the local script data is deserialized. For example, deserializer 1310 deserializes the local script data. At 1416, the local script data is distributed to the appropriate LED drivers on the paddle. For example, FPGA 1312 reformats the deserialized local script data so it goes to the correct LED driver. In some embodiments, once FPGA 1306 sends the data over to the paddle the data is streamed onto the LED drivers without any need to buffer the local frame information. For example, FPGA 1312 stores the local script data. At 1418, the LED drivers are loaded with the local script data. For example, LED drivers 1314-1318 are loaded with the local script data. In some embodiments, two or more LED drivers are mounted on a paddle to drive different sets of LEDs. In some embodiments, each LED driver receives a portion of the local script data (e.g., clock data, load data, and image data) corresponding to the LED driver. Some LED drivers do not have pulse width control. In this case, the image data in the local script data includes information about whether to turn on and off an LED for each clock cycle. At 1420, the LEDs are activated using the local script data.

In some embodiments, FPGAs 1112 and 1312 are not needed. For example, if a particular implementation is set up to address four LED drivers at the same time, the data comes out of deserializers 1110 and 1310 in parallel 24 bit and is broken up into four sets of data streams. In other embodiments, a component like a CPLD could be used to perform the same “translation” function.

Process 1400 may be desirable over process 1200 because it may be faster to use parallel processing. However, in some cases, there may be more components and greater complexity in the architecture of system 1300 compared with system 1100.

In various embodiments, the connections between the master controller/pre-processor and each paddle base can be implemented in a variety of ways. For example, there may be a direct connection between the master controller/pre-processor and each paddle base. For a large array of paddles, there may be a direct connection between the master controller/pre-processor and row and/or column of paddle bases. Multiplexing may be used to address each paddle in this case. The connection itself may be an optical or any other appropriate link.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for generating a display including:
a base on which one or more paddles are mounted, wherein each paddle includes a plurality of pixel elements and is configured to sweep out an area during a paddle cycle;
a processor configured to generate a script based at least in part on a pixel map and an image; and
a pixel element driver configured to receive at least a portion of the script and activate a pixel element on a paddle when the pixel element coincides with an image pixel of the image;
wherein at least a portion of the image is represented on the display by activating the pixel element.

2. A system as recited in claim 1, wherein the pixel element is a light emitting diode (LED).

3. A system as recited in claim 1, wherein the processor is a master processor configured to generate a master script for two or more paddles.

4. A system as recited in claim 1, wherein the processor is a local processor configured to generate a local script for the paddle.

5. A system as recited in claim 1, wherein the script is stored in SDRAM.

6. A system as recited in claim 1, further including a serializer configured to serialize at least a portion of the script.

7. A system as recited in claim 1, further including a paddle base comprising a portion of the base on which the paddle is mounted, wherein the portion includes one or more devices associated with the paddle.

8. A system as recited in claim 8, further including an optical link between the paddle base and the paddle.

9. A system as recited in claim 8, further including an optical link between the base and the paddle base.

10. A system as recited in claim 1, wherein the script comprises a sequence of data indicating which pixel elements on the paddle to activate, intensities associated with the pixel elements, and when to activate the pixel elements.

11. A system as recited in claim 1, wherein the script includes one or more of: LED driver chip control commands, timing information, LED current settings, and LED grayscale information.

12. A system as recited in claim 1, wherein the script is pre-generated or generated in real time.

13. A system as recited in claim 1, wherein the script comprises a master script and further comprising an FPGA configured to parse the master script into local script data for each paddle.

14. A method for providing a display including:
sweeping out an area during a paddle cycle, wherein sweeping is performed by one or more paddles mounted on a base, wherein each paddle includes a plurality of pixel elements;
generating a script based at least in part on a pixel map and an image; and
receiving at least a portion of the script and activating a pixel element on a paddle when the pixel element coincides with an image pixel of the image;
wherein at least a portion of the image is represented on the display by activating the pixel element.

15. A method as recited in claim 14, wherein the pixel element is a light emitting diode (LED).

16. A method as recited in claim 14, wherein a master processor is configured to generate a master script for two or more paddles.

17. A method as recited in claim 14, wherein a local processor is configured to generate a local script for the paddle.

18. A method as recited in claim 14, wherein the script comprises a sequence of data indicating which pixel elements on the paddle to activate, intensities associated with the pixel elements, and when to activate the pixel elements.

19. A method as recited in claim 14, wherein the script is pre-generated or generated in real time.

20. A method as recited in claim 14, wherein the script comprises a master script and wherein an FPGA is configured to parse the master script into local script data for each paddle.
